(19) United States
(12) Patent Application Publication
(10) Pub. No.: US 2014/0037058 A1
(43) Pub. Date: Feb. 6, 2014

(54) C-Arm with Removable or Retractable Detector Housing

(71) Applicant: Visuum, LLC, Gainesville, FL (US)

(72) Inventors: John R. Allen, Port Jefferson Station, NY (US); Daniel T. White, Gainesville, FL (US)

(73) Assignee: Visuum, LLC, Gainesville, FL (US)

(21) Appl. No.: 13/957,888

(22) Filed: Aug. 2, 2013

Related U.S. Application Data
(60) Provisional application No. 61/679,381, filed on Aug. 3, 2012.
(60) Provisional application No. 61/833,259, filed on Jun. 10, 2013.

(51) Int. Cl. H05G 1/02

(52) U.S. Cl. CPC H05G 1/02
USPC 378/62

(57) ABSTRACT

An x-ray system comprises a c-arm base unit, a detector tray and a c-arm movably supported on the base to permit articulation above a patient to be examined. The c-arm has an x-ray emitter emitting x-radiation in an x-ray field, an x-ray detector detecting the x-rays and removably resting at the detector tray. An upper portion of the c-arm holds the x-ray emitter. The c-arm has a retractable lower portion with an articulating assembly removably holding the detector tray at the lower end and articulating the detector tray away from or in towards a center of the c-arm to stowed positions when attached. The c-arm slides with respect to the upper portion of the c-arm such that, when retracted, the upper portion can be placed over the patent who is resting on a surface having an obstruction therebeneath that would prevent the lower portion from accessing under the surface.

### CROSS-REFERENCE TO RELATED APPLICATIONS

This application claims priority to U.S. Provisional Application Ser. Nos. 61/679,381, filed on Aug. 3, 2012, and 61/833,259, filed on Jun. 10, 2013, the entire disclosures of which are hereby incorporated herein by reference in their entireties.

### STATEMENT REGARDING FEDERALLY SPONSORED RESEARCH OR DEVELOPMENT

Not Applicable

### FIELD OF THE INVENTION

The present invention relates to an x-ray imaging system (whether mobile, portable or stationary) that incorporates a movable or detachable x-ray detector assembly on a mounting apparatus such as a c-arm, that permits an x-ray system to acquire desired x-ray images where current configurations, designs or regulations would not otherwise allow. The present invention also permits such a single x-ray imaging system to be interchangeably used for either radiographic or fluoroscopic imaging in medical applications, such as in hospital operating rooms, intensive care units, and emergency rooms, as well as outpatient settings such as trauma and imaging centers. More specifically, the present invention permits an x-ray imaging system's x-ray detector to be removed from the x-ray imaging field through movement on an articulating joint thus (i) allowing the entire system to be more easily moved or positioned around obstacles and (ii) accommodating use of alternate detectors, and methodologies and imaging techniques. In an exemplary embodiment, the so-called “single-panel solution” for taking radiographic images on an imaging device using a c-arm apparatus, the x-ray detector can be detached or removed from its detector tray or docking station that is mounted on a c-arm, independently repositioned apart from its tray or docking station (for example, moved underneath a patient), and its tray or docking station then removed from the x-ray field to permit acquisition of an unobstructed image.

The present invention also relates to a fully integrated x-ray detector panel, wherein some or all components of a traditional detector tray are alternatively contained in such panel, and the panel merely plugs into a system.

In an alternative embodiment, a mobile radiographic x-ray device involves a single base unit including a radiographic x-ray generator and a rotatable mast having an extendable horizontal arm with a radiographic x-ray tube and collimator mounted on the distal end with a rotatable connector, and a folding arm mounted on the lower portion of the rotatable mast that, when lowered into horizontal position, the folding arm has a detector or docking station attached, allowing the detector to be placed in alignment with the x-ray field. This configuration allows for easy positioning for fluoroscopic or radiographic imaging. When the folding arm is retracted and placed in its parked, upright position, the unit functions as a standard mobile radiographic x-ray system. This design allows for use of either a single detector (one that does both fluoroscopic and radiographic imaging) or a dual-detector solution (one for fluoroscopic imaging and a second detector for radiographic imaging).

### BACKGROUND OF THE INVENTION

C-arm devices are used primarily for obtaining fluoroscopy imaging in image-guided surgical procedures to assist a surgeon in navigating needles, catheters, and other surgical instruments, as well as identifying anatomical features during an invasive surgical procedure, for example. Other applications include diagnosis of disease and pathology, such as blocked arteries, aneurisms, and hemorrhaging, through the use of a contrast agent (such as iodine or barium) that can be, for example, injected into the patient's arterial or gastrointestinal system. Yet another application is the acquisition of radiographic images for post-surgical assessment of the procedure such as the proper setting of a bone and joint reconstruction. Some operating rooms are equipped with a fixed, floor- or ceiling-mounted c-arm fluoroscopy unit dedicated to image-guided surgical procedures. In many instances, the operating room does not have a dedicated c-arm, and mobile c-arm devices are used instead. Mobile c-arms can be moved from room to room, and are less expensive to own and operate than fixed c-arm systems.

In general, the major components of all c-arm imaging systems consist of a c-arm, an x-ray source, an x-ray detector, and one or more supporting structures (e.g., bases). The x-ray source and the x-ray detector are mechanically aligned by “C”-shaped frame or arm, regardless of the system's mobility. The detector is located on or near the end of the upper or lower portion of the c-arm while in operation, to align opposite the x-ray source. The detector is typically mounted onto or within a fixed, rigid mechanical assembly and permanently wired thereto. This mechanical assembly is also permanently affixed to the c-arm in a fixed location and position. While in certain designs, the c-arm itself can be rotated, elevated and translated laterally from its supporting structure, the detector's mechanical assembly remains rigidly affixed.

Portable or mobile c-arm devices utilize one or more base units. One base unit typically contains the device's operative components (i.e., c-arm, the x-ray source, and detector). If utilized, a second base unit then serves as the support for one or more display monitors; if so utilized, the second base unit is coupled to the first base with an umbilical cord having power and video data lines. Some mobile c-arm devices have an integrated display monitor in a single-base unit configuration.

Mobile c-arm devices do present some problems for surgery, not the least of which is a dedicated operator or technician to position and operate the device at all times during the surgical procedure. In image-guided surgical procedures, the device also necessarily penetrates the sterile field surrounding the surgical table. The device may also have to be moved and repositioned within the operating suite several times during a surgical procedure, which can delay or interrupt the procedure.

Many innovations have been made to improve the mobility and ease of movement for mobile c-arms. One such system with improved motion control is described in U.S. Pat. No. 7,597,473 B2 to Graumann et al., which issued on Oct. 6, 2009, and is incorporated herein in its entirety. Graumann teaches the use of two pivoting arms to rotate the c-arm about two rotational axes and a displacement arm that is extendible and retractable along a horizontal axis.

Another such system with improved motion control is described in U.S. Pat. No. 8,025,441 B2 to Fadler et al., which issued on Sep. 27, 2011, and is incorporated herein in its entirety. Fadler teaches the use of a movement system for the c-arm that facilitates the movement of the c-arm parallel to the surgical table without moving the c-arm base unit.

The systems taught by Graumann and Fadler, while effective in increasing the range of movement of the c-arm and reducing the amount of movement required of the base unit during surgical procedures, nonetheless suffer from common limitations that restrict the ability to acquire images of a patient who lies directly over the pedestal of the surgical table or to take full-sized (14 in×17 in) radiographic images.

When mobile c-arm x-ray systems were first introduced over thirty years ago, they were equipped with a mono-block x-ray generator that incorporated a high-voltage generator, an x-ray tube, and a collimator to produce the x-rays used to penetrate a patient's anatomy and expose an x-ray image intensifier. Typically, the image intensifier would have an active area of corresponding to a diameter between 6 inches to 12 inches. Over the past decade, image intensifiers on mobile c-arms have been replaced with flat-panel x-ray detectors, typically with an active imaging area of 9 inches by 9 inches. These flat-panel detectors have the advantage of a vertical profile less than a few inches, which can be compared with previous image intensifiers having a vertical profile of 12 inches or more. This reduces the size and volume of the image receptor that is normally placed over the patient during imaging, providing the surgeon with more room to operate when the c-arm is engaged over the surgical table. Flat panel detectors used for fluoroscopic imaging applications generally require a cooling system that uses either a liquid or forced-air recirculation system to maintain a constant temperature in the panel. Small temperature variations introduce differential dark current generation signals that degrade image quality during fluoroscopic imaging modes due to the very low exposure doses used during fluoroscopic imaging. Consequently, all flat-panel x-ray detectors used for fluoroscopic imaging require permanently mounting on a c-arm device.

There are a number of fixed-mounted, flat-panel fluoroscopic detectors currently on the market made by several manufacturers including Canon, Inc., Varian Medical Systems, Inc., Thales, and Perkin Elmer, for example. These manufacturers, along with several others, make flat-panel detectors that can produce radiographic images. In fluoroscopy, these detector panels are used in conjunction with a docking station (similar to a radiographic cassette tray) equipped with an active cooling system (air or liquid). More recently, Canon, Inc., introduced a new flat-panel detector that the company maintains can acquire both radiographic and fluoroscopic imaging without the use of a liquid cooling system.

Until recently, all flat-panel detectors (including radiographic panels) required a wired connection (tethered) to a central processing unit. The latest generation of radiographic flat-panel detectors include panels that communicate data and images wirelessly. Taking advantage of these innovations, these panels can now be used in multiple rooms or multiple locations within the same room.

Mobile or portable radiographic x-ray systems are generally used in hospitals and clinics primarily for patients who are unable to be moved to the radiology department for x-ray imaging (for example, patients in Intensive Care Units (ICU)). One such system is described in U.S. Pat. No. 5,784,435 to Figurski, issued on Jul. 21, 1998, which is incorporated herein in its entirety. Figurski teaches the use of a base unit having a rotatable x-ray source support column for allowing the x-ray source to move in a 360-degree circle about the base unit. These mobile or portable x-ray radiographic systems consist of a radiographic x-ray generator, an x-ray tube, and a collimator to acquire x-ray images, and use either a wireless or tethered digital x-ray detector or a Computed Radiography (CR) cassette. In these applications, the x-ray technician must manually position the x-ray cassette or detector under the patient and manually align the x-ray source with the detector using the light emitted from the collimator as a guide. These systems do not incorporate a c-arm apparatus because the imaging techniques do not require the same degree of accuracy as fluoroscopic imaging. If a fluoroscopic image is required in a hospital setting, for example, the patient is sent to the radiology department or the radiology department arranges for the local deployment of a separate portable or mobile c-arm device. In other words, inherent design and technological limitations, as well as cost factors, have prevented a cost-effective solution to dual-use (radiographic and fluoroscopic) systems, especially in the portable or mobile product categories.

Thus, a need exists to overcome the problems with the prior art systems, designs, and processes as discussed above.

### SUMMARY OF THE INVENTION

The invention provides an x-ray imaging system with a movable and detachable x-ray detector assembly, capable of mounting on an apparatus such as a c-arm, u-arm, or other support structure that overcomes the hereinafore-mentioned disadvantages of the heretofore-known devices and methods of this general type, and that (i) allows the entire system to be more easily moved or positioned around obstacles and (ii) accommodates use of one or more alternate detectors, and methodologies and imaging techniques, specifically to obtain both fluoroscopic and radiographic images of patients (including radiographic images of those anatomical regions that lie directly over the pedestal of an operating table or any other obstruction that may be encountered in the x-ray imaging area and without the need for moving the patient to another area or substituting x-ray systems).

One exemplary embodiment of the present invention is a mobile x-ray c-arm that has an articulating detector tray or docking station that holds or supports the detector, affixed to a ball joint capable of moving (e.g., retracting) the tray or station on one or more vertical and horizontal planes or permitting detachment from the supporting structure (e.g., c-arm) for remote use independent of the tray or station (such as removing the detector panel from its docking station and placing it directly underneath a patient's anatomy), whether tethered or wireless. In this fashion, a detector panel such as Canon, Inc.'s CXDI 50RF may be used as a single detector in acquiring both fluoroscopic and radiographic images using the same x-ray unit. In other words, the present invention allows an x-ray device, such as a mobile c-arm, that was otherwise dedicated solely to fluoroscopic imaging to achieve a cost-effective, dual-use in radiography also, without the need to move or transport the patient or to deploy a separate radiographic x-ray unit. In this instance, the operator positions the c-arm, removes the detector panel, retracts the docking station if necessary, aligns the collimator light field with the panel and acquires a radiographic image. Certain x-ray imaging techniques can thus now be rather easily achieved, such as positioning directly above the pedestal of a surgical table, using existing c-arm designs. If the lower portion of the c-arm is also retractable, it can slide upwards into or over the preceding portions of the c-arm apparatus, thereby permitting even more clearance of object or from imaging fields since the tray or docking station can be moved further away. The detector tray can also be folded outwards or inwards towards the center of the c-arm, or towards the left or right, to remove any obstructions that would prevent, for example, the c-arm from moving closer to the pedestal of the surgical table or a patient's bed. The mobile c-arm base unit can provide any and all of the positioning mechanisms required to elevate the c-arm, rotate it about one or more horizontal or vertical axes, and shift it parallel to the surgical table. In an alternative exemplary embodiment of the invention, a so-called “dual-panel solution,” the mobile x-ray c-arm is equipped with a fixed-mount, flat-panel x-ray detector capable of producing fluoroscopic images (such as the Paxscan 3030+ manufactured by Varian Medical Systems, Inc. or its competitive equivalent) and a second flat-panel x-ray detector, such as a wireless radiographic panel (e.g., the Paxscan 4336W) is used to acquire radiographic images. Alternatively, if the CXDI-50RF is used, it can be left in the sensor tray and folded out of the way when a radiographic image is to be taken while a second sensor panel, such as a wireless sensor panel, can be used to acquire the radiographic image.

In another alternative exemplary embodiment, a mobile radiographic x-ray device involves a single base unit including a radiographic x-ray generator and a rotatable mast having an extendable horizontal arm with a radiographic x-ray tube and collimator mounted on the distal end with a rotatable connector, and a folding arm mounted on the lower portion of the rotable mast that, when lowered into horizontal position, the folding arm has a detector or docking station attached allowing the detector to be placed in alignment with the x-ray field. This configuration allows for easy positioning for fluoroscopic or radiographic imaging. When the folding arm is retracted and put in its parked, natural upright position, the device functions as a standard mobile radiographic x-ray system. This design allows for either a single-panel solution (e.g., a single detector panel capable of performing both fluoroscopic and radiographic imaging) or a dual-panel solution (e.g., a single detector panel dedicated solely for use with fluoroscopic imaging and a second detector panel dedicated solely for use with radiographic imaging).

In yet another alternative exemplary embodiment of the invention, a mobile radiographic x-ray device is modified so that a c-arm with a retractable lower portion is mounted on the distal end of the horizontal arm. The radiographic x-ray tube and collimator are mounted on one end of the c-arm and the retractable x-ray detector tray is mounted on the other end. The x-ray generator in the base unit is replaced with a generator and detector capable of producing both radiographic and fluoroscopic imaging. With these modifications, a mobile radiographic unit becomes capable of producing all of the traditional radiographic images it was designed to produce as well as all of the fluoroscopic images that a traditional mobile c-arm is designed to do.

When the detector is detached from the detector tray, the lower portion of the c-arm can be retracted and the detector tray can be folded up to move a mobile c-arm's base unit closer to the surgical table. The detached detector can be coupled to a detector cable attached to the base unit and then placed under the patient to acquire radiographic images at any location along the table. In this cabled mode, radiographic images can be acquired in a similar fashion as with a mobile radiographic x-ray system used in ICU applications. Here, the detector is manually positioned under the patient and the mobile c-arm base unit is positioned so that the x-ray source is pointed at the detector.

Using a detector having a sufficiently-sized active area (for example, 14 inches by 17 inches active area of the CXDI-50RF), a full-sized radiographic image can be acquired and displayed within a fraction of a second of acquisition to provide the surgeon with immediate radiographic evidence of the status of the surgical procedure, especially for post-operative confirmation of the efficacy of a procedure. In many cases prior to the instant invention, surgeons have had to wait for up to twenty or thirty minutes after the procedure has been completed to get radiographic confirmation of the status of the patient's surgically repaired anatomical structure. This delay is expanded when the c-arm and/or its operator, who is generally employed by the radiology department, has left the operating room and is engaged elsewhere. The delay is also exacerbated if the post-operative radiographic exam has to be completed in the radiology department or if the c-arm, having already been moved from the operating room, needed to be recalled to the operating room. Such delay greatly reduces the patient throughput of an operating room and, if the patient requires additional surgery, the operating room has to be prepared for another surgical procedure incurring additional costs.

In an alternative embodiment, the mobile radiographic unit is equipped with a fixed-mounted fluoroscopic flat-panel detector such as the Paxscan 3030+ and a second radiographic panel such as the Paxscan 4336W or their equivalents. The fixed-mounted fluoroscopic panel remains in the detector tray and folded out of the way and the radiographic panel is used to take radiographic images.

With the foregoing and other objects in view, there is provided, in accordance with the invention, an x-ray system comprises a c-arm base unit, a detector tray and a c-arm movably supported on the base to permit articulation above a patient to be examined. The c-arm has an x-ray emitter emitting x-radiation in an x-ray field, an x-ray detector detecting the x-rays and removably resting at the detector tray. An upper portion of the c-arm holds the x-ray emitter. The c-arm has a retractable lower portion with an articulating assembly removably holding the detector tray at the lower end and articulating the detector tray away from or in towards a center of the c-arm to stowed positions when attached. The c-arm slides with respect to the upper portion of the c-arm such that, when retracted, the upper portion can be placed over the patent who is resting on a surface having an obstruction therebeneath that would prevent the lower portion from accessing under the surface.

With the objects of the invention in view, there is also provided a mobile x-ray system, comprising a base unit having a rotatable mast having an extendable horizontal arm with a distal end, a detector tray, and a c-arm mounted at the distal end of the horizontal arm to permit the c-arm to rotate, elevate, and translate relative to the mast above a patient to be examined. The c-arm has an x-ray emitter operable to emit x-radiation and project an x-ray field when activated, an x-ray detector operable to detect the x-rays emitted from an x-ray emitter and shaped to removably rest at the detector tray, an upper portion has an upper end at which is disposed the x-ray emitter, a lower part, and a retractable lower portion has a lower end and an articulating assembly operable to removably hold the detector tray at the lower end and to articulate the detector tray away from or in towards a center of the c-arm to at least one stowed position when attached thereto, and is shaped to slide into or over the lower part of the upper portion of the c-arm such that, when retracted, the upper portion can be placed over the patent who is resting on a surface having an obstruction therebeneath that would prevent the lower portion from accessing therebelow.

In accordance with another feature of the invention, there is provided a computer operably connected to the detector tray directly or wirelessly and operable to process images received by the detector tray.

In accordance with a further feature of the invention, the detector tray comprises a removable x-ray scatter grid, a removable ion chamber, a removable sensor, and a removable lead shield 11.

In accordance with an added feature of the invention, the removable sensor is a dynamic x-ray detector, a radioscopic x-ray detector, and/or a fluoroscopic x-ray detector.

In accordance with an additional feature of the invention, the x-ray detector is fixed in the detector tray. In accordance with yet another feature of the invention, there is provided a

In accordance with yet a further feature of the invention, the x-ray detector is a dynamic x-ray detector, a radioscopic x-ray detector, and/or a fluoroscopic x-ray detector.

In accordance with yet an added feature of the invention, the computer is connected to the x-ray detector at the detector tray through the articulating assembly and which further comprises an umbilical cord connected to the computer and providing removable connectivity to x-ray detector at the detector tray when the detector tray is detached from the articulating assembly.

In accordance with yet an additional feature of the invention, the x-ray emitter is coupled to the c-arm with a locking bearing assembly permitting the x-ray generator to at least one of rotate and pivot up and down independently from the c-arm and, thereby, permit acquisition of radiographic images when one of the x-ray detector is removed from the detector tray or the detector tray is removed from the articulating assembly.

In accordance with again another feature of the invention, the x-ray detector is two x-ray detectors, one coupled to the detector tray and one coupled through an umbilical cord.

In accordance with again a further feature of the invention, one of the sensors is a fluoroscopic imaging sensor and the other of the sensors is a radiographic imaging sensor.

In accordance with again an added feature of the invention, the removable sensor is two removable sensors, one coupled to the detector tray and one coupled through an umbilical cord.

In accordance with again an additional feature of the invention, the x-ray emitter is a mono-block x-ray generator comprising an x-ray generator, an x-ray tube, and a collimator.

In accordance with still another feature of the invention, the x-ray emitter comprises a collimator light operable to project a light field superimposed over the x-ray field projected through the collimator.

In accordance with still a further feature of the invention, the light field is an LED projecting a uniformly illuminated area of light and/or a laser creating a cross hair defining the center of the beam and the boundaries of the x-ray exposure field.

In accordance with still an added feature of the invention, the c-arm base unit is one of mobile, portable, and fixed.

In accordance with still an additional feature of the invention, the base unit comprises a rotatable mast having an extendable horizontal arm with a distal end and the c-arm is mounted at the distal end of the horizontal arm.

In accordance with still another feature of the invention, the x-ray detector can be removed from the detector tray and coupled to the base unit through at least one of a cord and wirelessly.

In accordance with yet an additional feature of the invention, the x-ray detector is two sensors, one coupled to the detector tray and one coupled through the at least one of the cord and wirelessly and one of the sensors is a fluoroscopic imaging sensor and the other of the sensors is a radiographic imaging sensor.

In accordance with a concomitant feature of the invention, the rotatable mast is no greater than 6′8″ high.

Although the invention is illustrated and described herein as embodied in a mobile c-arm with a detachable radiographic detector, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a schematic side elevational view of an exemplary embodiment of a mobile c-arm according to the present invention with a retractable lower portion of the c-arm in an extended position, with the detector tray in a deployed position, with a removable detector attached to the detector tray and placed under a patient on a surgical table, and with a base unit having one or more display monitors;

FIG. 2 is a schematic, exploded, perspective view of an exemplary embodiment of a detector tray according to the present invention with an ion chamber, a removable grid, a removable detector, and lead backing to provide a primary barrier to x-rays transmitted through the detector tray;

FIG. 3 is a schematic side elevational view of an exemplary embodiment of the mobile c-arm of FIG. 1 with the lower portion of the c-arm retracted and the detector tray in a stowed position, with the detector attached to a cable and placed under a patient on a surgical table, and with a base unit having one or more display monitors;

FIG. 4 is a schematic side elevational view of an exemplary embodiment of a mobile radiographic unit according to the present invention with a c-arm assembly attached to a distal end of a horizontal arm, with a lower portion of the c-arm retracted, with a detector tray in a stowed position, with the detector attached to a cable and placed under a patient on a surgical table or hospital bed, and with a base unit having one or more display monitors;

FIG. 5 is a schematic side elevational view of one exemplary configuration of the mobile radiographic unit of FIG. 4;

FIG. 6 is a schematic side elevational view of one exemplary configuration of the mobile radiographic unit of FIG. 4 with the lower portion of the c-arm extended and the detector tray in a deployed position, with the detector attached to the detector tray, and with the detector tray and detector placed under a patient on a surgical table;

FIG. 7 is a schematic side elevational view of an exemplary configuration of a fixed c-arm according to the invention with a detector arm and tray in a stowed position; and

FIG. 8 is a schematic side elevational view of an exemplary configuration of a mobile c-arm configuration of the embodiment of FIG. 7 with the detector arm and tray in an extended position.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

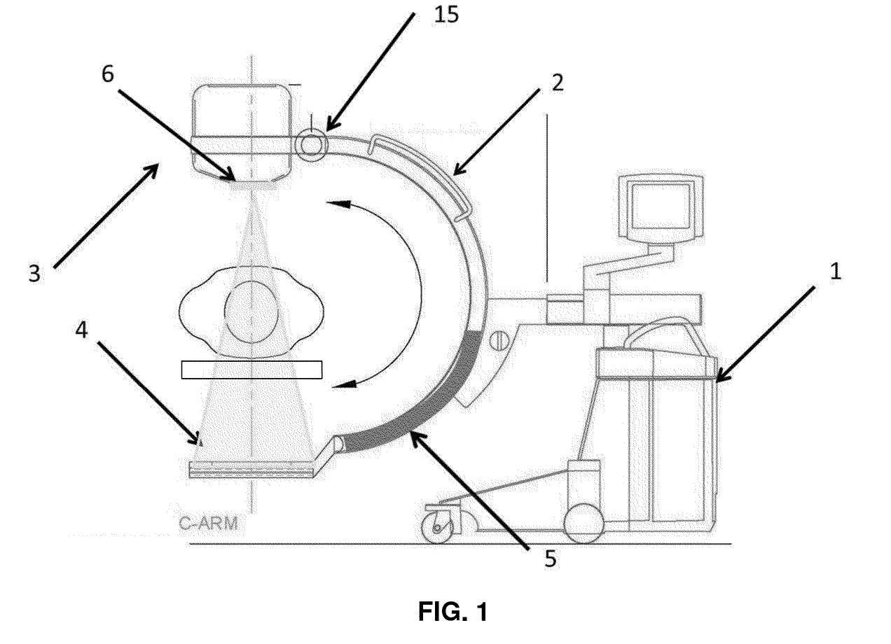

Described now are exemplary embodiments of the present invention. Referring now to the figures of the drawings in detail and first, particularly to FIG. 1, there is shown a first exemplary embodiment of a mobile c-arm base unit 1 that supports a c-arm 2. The c-arm 2 can rotate, elevate, and translate relative to the base unit 1. The c-arm 2 has an x-ray generator 3 (e.g., a mono-block x-ray generator) that comprises an x-ray generator, an x-ray tube, and a collimator attached on one end of the c-arm 2. The mono-block generator 3 contains a collimator light 6 that projects a light field superimposed over the x-ray field projected through the collimator. The light field can either be an LED projecting a uniformly illuminated area of light or a laser creating a cross hair defining the center of the beam and the boundaries of the x-ray exposure field.

The c-arm 2 also has a retractable lower portion 5 that supports a detector tray 4 at an end thereof. The retractable lower portion 5 of the c-arm 2 can be slid up into (and/or over) the upper portion of the c-arm 2 and the detector tray 4 can be folded in towards the center of the c-arm 2 to a stowed position. The detector tray 4 is illustrated in the figures as folding up in a single direction in the plane of the c-arm. This orientation, however, is merely exemplary and can articulate in any direction with regard to the c-arm or within any plane about the articulation point. In an exemplary embodiment, the articulation joint is a ball-joint and, therefore, can pivot or articulate in every direction about three axes.

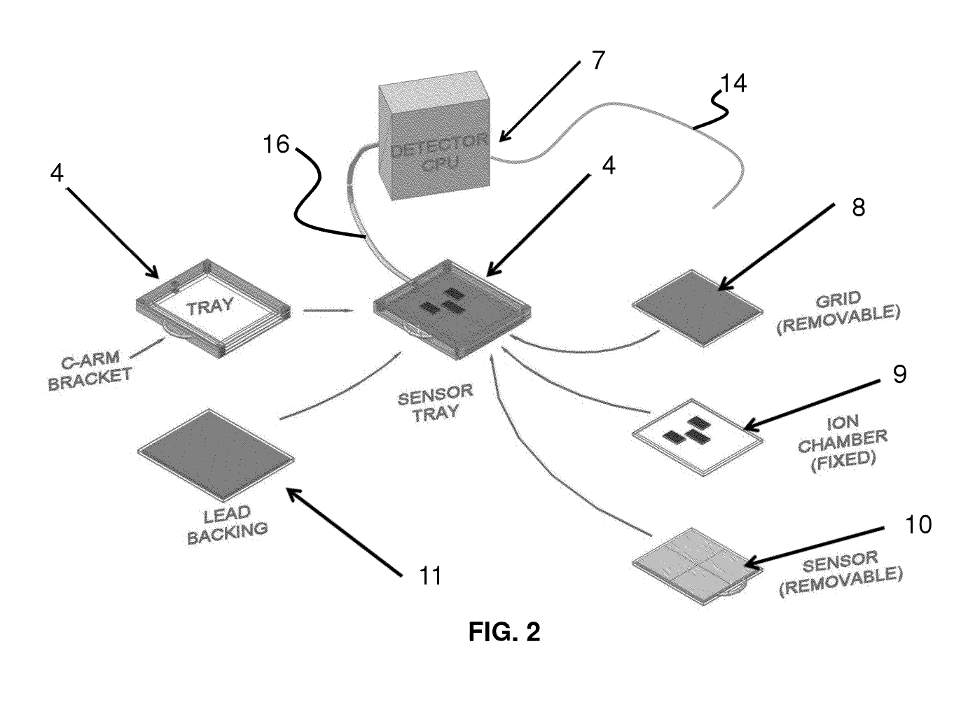

With regard to FIG. 2, an exemplary embodiment of the detector tray 4 is shown coupled to a detector CPU 7 (housed in the base unit 1) through an umbilical cord 16 containing power and data lines. The detector tray 4 contains a removable x-ray scatter grid 8, an ion chamber 9, a removable detector or sensor 10, and a lead shield 11. The detector tray 4 also contains a set of cooling fans to provide forced-air cooling for the detector when it operates in fluoroscopic imaging mode. In accordance with an exemplary embodiment, the sensor 10 is a removable CXDI-50RF digital x-ray detector manufactured by Canon, Inc or a fixed-mounted fluoroscopic x-ray detector such as the Paxscan 3030+ manufactured by Varian Medical Systems, Inc. A second umbilical cord 14 is attached to the detector CPU 7 to provide connectivity to the removable detector 10 when detached from the detector tray 4. If a wireless sensor is used to acquire radiographic images, the umbilical cord 14 is not required to connect the radiographic detector to the CPU 7.

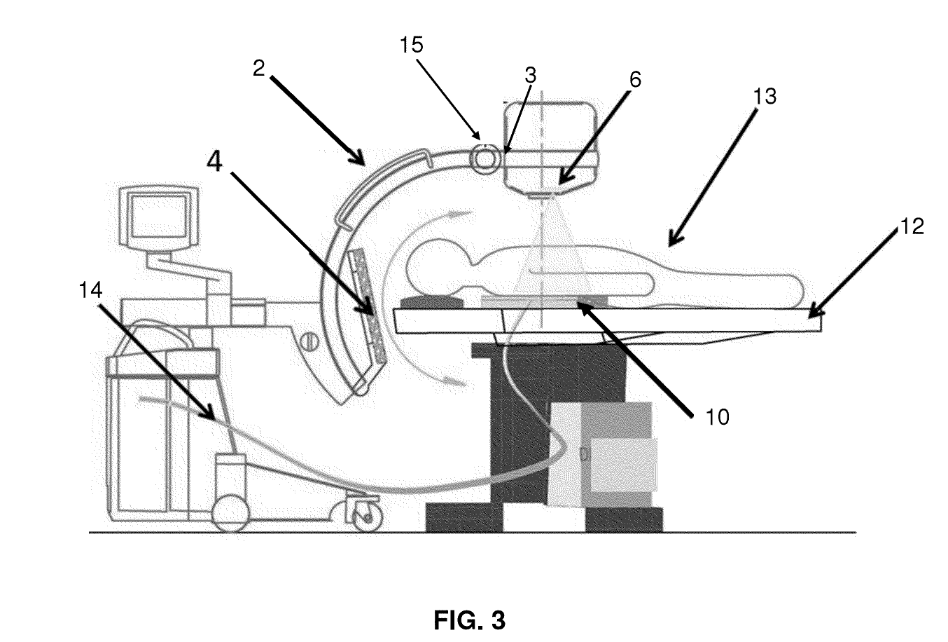

If the detector 10 is removed from the detector tray 4 and the retractable lower portion 5 of the c-arm 2 is retracted, as shown in FIG. 3, the detector 10 can be positioned under a patient 13 who, in this exemplary embodiment, rests on a surgical table 12. The c-arm base unit 1 can be positioned near the surgical table 12 so that a radiographic image can be obtained even if the detector 10 (positioned under the patient 13) is above the pedestal of the surgical table 12, which pedestal would prohibit movement of a prior art c-arm. The generator 3 is coupled to the c-arm 2 with a locking bearing assembly 15 (see FIG. 1) that allows the generator 3 to rotate or pivot up and down independently from the c-arm 2 to permit acquisition of radiographic images when the detector 10 is removed from the detector tray 4. Alternatively, the fluoroscopic flat-panel detector 10 can be left in the detector tray 4 and a second flat-panel detector 10 used to acquire the radiographic images.

Although not illustrated, the articulation joint can include a quick-connector assembly that allows the detector tray 4 to be removed easily by a user. In this manner, either a removable sensor 10 can be moved about as needed with the detector tray 4 connected to the lower portion 5 of the c-arm 2, or the detector tray 4 can be entirely removed along with the sensor 10 and utilized in any position as desired.

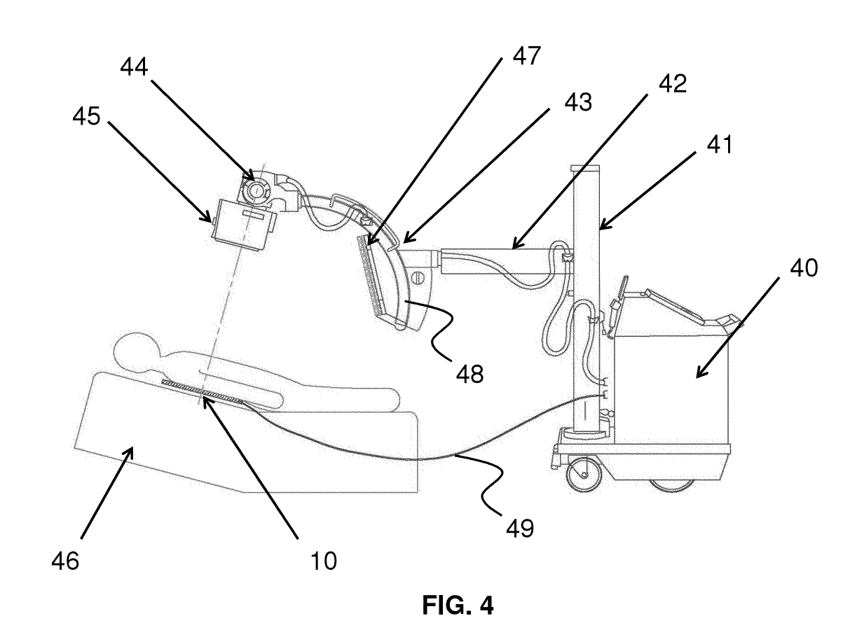

FIG. 4 illustrates the ability of a mobile radiographic unit 40 according to another exemplary embodiment that can be used directly above a patient's bed 46, even though the x-ray generator is directly above the sub-structure of the bed. The mobile radiographic unit 40 has a rotatable mast 41 with an extendable horizontal arm 42. A c-arm 43 is mounted at the distal end of the horizontal arm 42. The c-arm 43 has a stowable and/or removable detector tray 47 mounted on one end of a retractable portion 48 of the c-arm 43. Here, the retractable portion 48 is in a retracted position and the detector tray 47 is in a stowed position. As above, this stowed position is only an exemplary orientation for articulation of the detector tray 47. The radiographic x-ray tube 44 and collimator 45 are mounted on end of the c-arm 43 opposite the retractable portion 48. In the exemplary configuration shown in FIG. 4, the detector 10 is coupled to the base unit 40 through an umbilical cord 49 and, as such, can be placed under a patient or mounted in the detector tray 47 as desired.

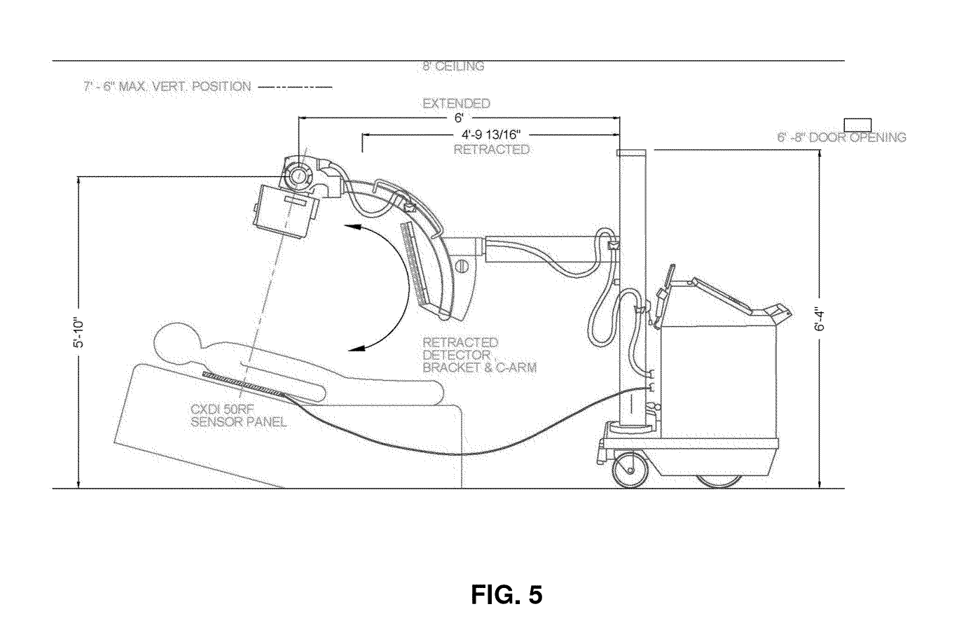

An exemplary configuration of the mobile radiographic unit 40 with the retractable portion 48 of the c-arm 43 in the retracted position and the detector tray 47 in the stowed position is shown in FIG. 5. Here, one example of a size of each the parts is shown. The rotatable mast 41 is 6′4″ so that it can easily fit within a standard 6′8″ door opening. The horizontal arm 42 is shown in an extended position 6′ away from the rotatable mast 41 and can be retracted to about 4′9″ therefrom. The radiographic x-ray tube 44 is shown as being positioned at the upper end of the c-arm 43 at 5′10″ from the floor.

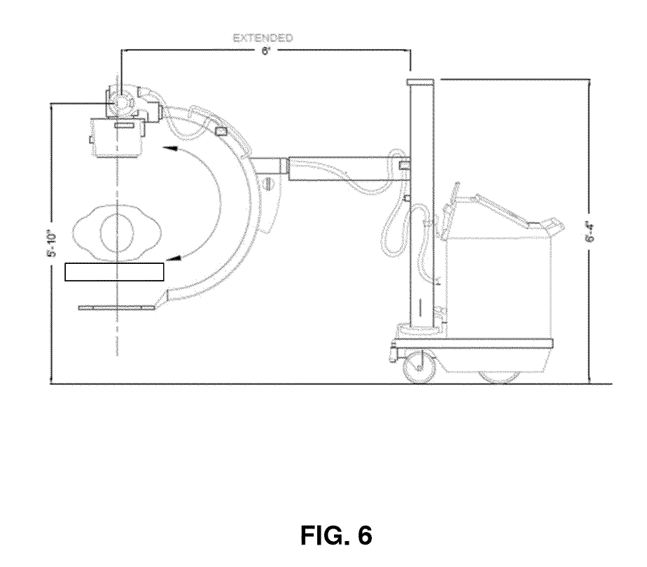

In comparison, the exemplary configuration of the mobile radiographic unit 40 in FIG. 6 illustrates the retractable portion 48 of the c-arm 43 in the extended position and detector 10 coupled within the detector tray 47, the latter being in the deployed position. Here, the mobile radiographic unit 40 is being used on a patient 13 lying on a surgical table 12 where access under the table 12 is available and not obstructed.

The detector 10 has been described herein as being either in the detector tray 4, 47 or separated therefrom and placed under a patient 13. These configurations, however, are not mutually exclusive. With a dual-detector system, two detectors 10 can be provided, one coupled to the detector tray 4, 47 and one coupled through the umbilical cord 14, 49. In an exemplary embodiment, one of the detectors 10 can be configured for fluoroscopic imaging and fixed to the lower portion of the c-arm and retracted or moved to allow for close positioning of the system for a second detector 10 that can be used for radiographic imaging. Even though the detector 10 is shown herein as being coupled with an umbilical cord 14, 49, the detector 10 in any embodiment described herein can communicate wirelessly to the base 1, 40. Alternatively, the system can be configured with a dual-purpose detector and a wireless radiographic detector 10 so that radiographic imaging can be performed without the need to remove the detector from the detector tray 4, 47 or to have an umbilical cord 14, 49 for the radiographic detector 10.

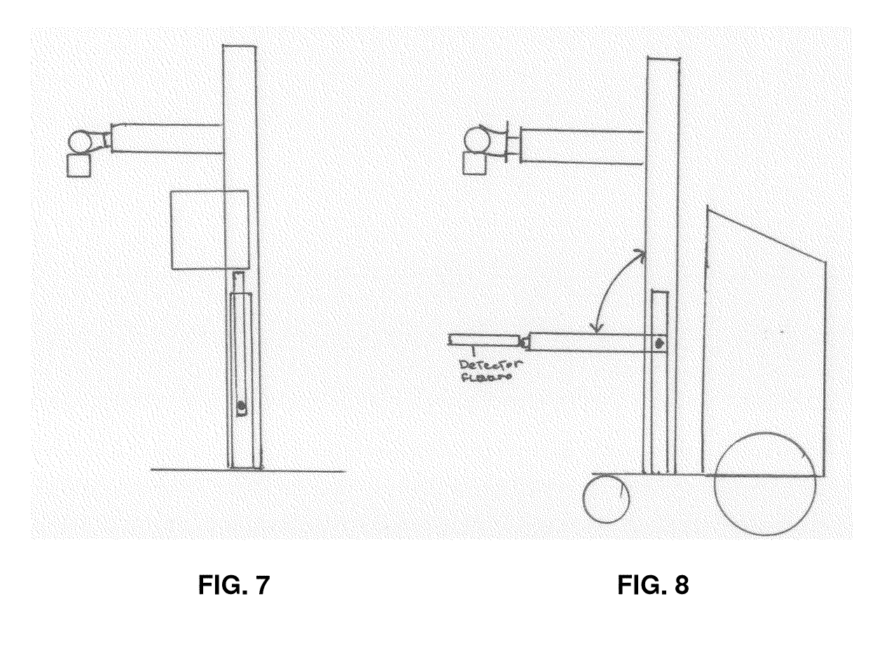

FIG. 7 is a schematic side view of one exemplary configuration of the mobile radiographic unit with the lower portion folded into a park position when fluoroscopic imaging is not required. When the folding arm is retracted and put in its parked, upright position, the unit functions as a standard mobile radiographic x-ray system.

FIG. 8 is a schematic side view of one exemplary configuration of a mobile radiographic x-ray device involves a single base unit including a radiographic x-ray generator and a rotatable mast having an extendable horizontal arm with a radiographic x-ray tube and collimator mounted on the distal end with a rotatable connector, and a folding arm mounted on the lower portion of the rotatable mast that, when lowered into horizontal position, the folding arm has a detector or docking station attached, allowing the detector to be placed in alignment with the x-ray field.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An x-ray system, comprising:
a c-arm base unit;
a detector tray; and
a c-arm movably supported on the c-arm base unit to permit the c-arm to rotate, elevate, and translate relative to the base unit above a patient to be examined, the c-arm comprising:
an x-ray emitter operable to emit x-radiation and project an x-ray field when activated;
an x-ray detector operable to detect the x-rays emitted from an x-ray emitter and shaped to removably rest at the detector tray;
an upper portion having:
an upper end at which is disposed the x-ray emitter; and
a lower part; and
a retractable lower portion:
having a lower end;
having an articulating assembly operable to removably hold the detector tray at the lower end and to articulate the detector tray away from or in towards a center of the c-arm to at least one stowed position when attached thereto; and
shaped to slide into or over the lower part of the upper portion of the c-arm such that, when retracted, the upper portion can be placed over the patent who is resting on a surface having an obstruction therebeneath that would prevent the lower portion from accessing therebelow.

2. The x-ray system according to claim 1, which further comprises a computer operably connected to the detector tray directly or wirelessly and operable to process images received by the detector tray.

3. The x-ray system according to claim 1, wherein the detector tray comprises a removable x-ray scatter grid, a removable ion chamber, a removable sensor, and a removable lead shield 11.

4. The x-ray system according to claim 3, wherein the removable sensor is one of:
a dynamic x-ray detector;
a radioscopic x-ray detector;
a fluoroscopic x-ray detector;

5. The x-ray system according to claim 1, wherein the x-ray detector is fixed in the detector tray.

6. The x-ray system according to claim 5, wherein the x-ray detector is one of:
a dynamic x-ray detector;
a radioscopic x-ray detector; and
a fluoroscopic x-ray detector.

7. The x-ray system according to claim 2, wherein the computer is connected to the x-ray detector at the detector tray through the articulating assembly and which further comprises an umbilical cord connected to the computer and providing removable connectivity to x-ray detector at the detector tray when the detector tray is detached from the articulating assembly.

8. The x-ray system according to claim 3, wherein the x-ray emitter is coupled to the c-arm with a locking bearing assembly permitting the x-ray generator to at least one of rotate and pivot up and down independently from the c-arm and, thereby, permit acquisition of radiographic images when one of:
the x-ray detector is removed from the detector tray; and
the detector tray is removed from the articulating assembly.

9. The x-ray system according to claim 1, wherein the x-ray detector is two x-ray detectors, one coupled to the detector tray and one coupled through an umbilical cord.

10. The unit according to claim 9, wherein one of the sensors is a fluoroscopic imaging sensor and the other of the sensors is a radiographic imaging sensor.

11. The x-ray system according to claim 4, wherein the removable sensor is two removable sensors, one coupled to the detector tray and one coupled through an umbilical cord.

12. The x-ray system according to claim 1, wherein the x-ray emitter is a mono-block x-ray generator comprising an x-ray generator, an x-ray tube, and a collimator.

13. The x-ray system according to claim 12, wherein the x-ray emitter comprises a collimator light operable to project a light field superimposed over the x-ray field projected through the collimator.

14. The x-ray system according to claim 13, wherein the light field is at least one of:
an LED projecting a uniformly illuminated area of light; and
a laser creating a cross hair defining the center of the beam and the boundaries of the x-ray exposure field.

15. The x-ray system according to claim 1, wherein the a c-arm base unit is one of mobile, portable, and fixed.

16. The x-ray system according to claim 1, wherein:
the base unit comprises a rotatable mast having an extendable horizontal arm with a distal end; and
the c-arm is mounted at the distal end of the horizontal arm.

17. A mobile x-ray system, comprising:
a base unit having:
a rotatable mast having an extendable horizontal arm with a distal end;
a detector tray; and
a c-arm mounted at the distal end of the horizontal arm to permit the c-arm to rotate, elevate, and translate relative to the mast above a patient to be examined, the c-arm having:
an x-ray emitter operable to emit x-radiation and project an x-ray field when activated;
an x-ray detector operable to detect the x-rays emitted from an x-ray emitter and shaped to removably rest at the detector tray;
an upper portion having:
an upper end at which is disposed the x-ray emitter; and
a lower part; and
a retractable lower portion:
having a lower end;
having an articulating assembly operable to removably hold the detector tray at the lower end and to articulate the detector tray away from or in towards a center of the c-arm to at least one stowed position when attached thereto; and
shaped to slide into or over the lower part of the upper portion of the c-arm such that, when retracted, the upper portion can be placed over the patent who is resting on a surface having an obstruction therebeneath that would prevent the lower portion from accessing therebelow.

18. The unit according to claim 17, wherein the x-ray detector can be removed from the detector tray and coupled to the base unit through at least one of a cord and wirelessly.

19. The unit according to claim 18, wherein the x-ray detector is two sensors, one coupled to the detector tray and one coupled through the at least one of the cord and wirelessly and one of the sensors is a fluoroscopic imaging sensor and the other of the sensors is a radiographic imaging sensor.

20. The unit according to claim 17, wherein the rotatable mast is no greater than 6′8″ high.
